(19) United States
(12) Patent Application Publication
(10) Pub. No.: US 2026/0072605 A1
(43) Pub. Date: Mar. 12, 2026

(54) SYSTEMS, METHODS, AND APPARATUS FOR PARTITIONING FOR MULTI-USER SHARED COMPUTING DEVICES

(71) Applicants: Ming Wu, Shanghai (CN); Addicam Sanjay, Chandler, AZ (US); Fujin Huang, Shanghai (CN); Peng Zhang, Shanghai (CN); Weiyu Zhang, Shanghai (CN); Jiejie Wang, Shanghai (CN)

(72) Inventors: Ming Wu, Shanghai (CN); Addicam Sanjay, Chandler, AZ (US); Fujin Huang, Shanghai (CN); Peng Zhang, Shanghai (CN); Weiyu Zhang, Shanghai (CN); Jiejie Wang, Shanghai (CN)

(21) Appl. No.: 19/395,875

(22) Filed: Nov. 20, 2025

(30) Foreign Application Priority Data
Dec. 20, 2024 (WO) PCT/CN2024/140878

(51) Int. Cl. G06F 3/06

(52) U.S. Cl. CPC G06F 3/0644; G06F 3/0604; G06F 3/0679

(57) ABSTRACT

An example shared computing device comprises a network interface to provide access to a first cloud storage including first user data associated with a first user and a second cloud storage including second user data associated with a second user, a local storage including a first partition with a first partition size, where the first partition stores a subset of the first cloud storage, and a second partition with a second partition size, where the second partition stores a subset of the second cloud storage, and a partition manager to cause a change to the first partition size based on a first cache rate of the first partition and a second cache rate of the second partition, where the cache rates are a percentage of the first cloud storage and the second cloud storage stored in the respective partition.

### RELATED APPLICATIONS

This patent claims priority to International Application No. PCT/CN2024/140878, which was filed on Dec. 20, 2024. International Application No. PCT/CN2024/140878 is hereby incorporated herein by reference in its entirety.

### BACKGROUND

Computing device sharing enables multiple users to share the same computing device at the same or different times. Cloud storage of data for shared computing device users has grown in popularity due to security and privacy considerations as well as size limitations of physical storage of the shared computing device.

### BRIEF DESCRIPTION OF THE DRAWINGS

FIG. 1 is a diagram illustrating a shared computing device with limited physical local storage.

FIG. 2 is a block diagram illustrating an example shared computing device with self-adaptive cloud storage cache partitioning mechanism in accordance with teachings disclosed herein.

FIG. 3 is a block diagram illustrating an example of local cache storage management in the example shared computing device of FIG. 2 in accordance with teachings disclosed herein.

FIG. 4A is a diagram illustrating a logical view of Pre-boot Read-Write Proxy and Run-time Read-Write Proxy in the example shared computing device of FIG. 2 in accordance with teachings disclosed herein.

FIG. 4B is a diagram illustrating a physical view of Pre-boot Read-Write Proxy and Run-time Read-Write Proxy in the example shared computing device of FIG. 2 in accordance with teachings disclosed herein.

FIG. 5 is a block diagram illustrating an example of initialization and allocation of an example index table in the example shared computing device of FIG. 2 in accordance with teachings disclosed herein.

FIGS. 6A-6C are block diagrams illustrating an example of access, release, and expansion of virtual local storage in the example shared computing device of FIG. 2 in accordance with teachings disclosed herein.

FIG. 7 is a flowchart illustrating an example process for allocation of a new virtual local storage to physical cache storage and physical cache storage optimization in the example shared computing device of FIG. 2 in accordance with teachings disclosed herein.

FIG. 8 is a diagram illustrating an example physical cache storage in different stages of the example process of FIG. 7 in accordance with teachings disclosed herein.

FIG. 9 is a flowchart illustrating an example process for initialization of the physical cache storage and read/write in the example shared computing device of FIG. 2 in accordance with teachings disclosed herein.

FIG. 10 is a block diagram illustrating on-the-fly reading/writing from virtual local storage in the example shared computing device of FIG. 2 in accordance with teachings disclosed herein.

FIG. 11 is a block diagram of an example processing platform including programmable circuitry structured to execute, instantiate, and/or perform the example machine readable instructions and/or perform the example operations of FIGS. 7 and 9 to implement the example shared computing device of FIG. 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 7 and 9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts.

### DETAILED DESCRIPTION

Computing devices may be shared across multiple users in a time-shared manner in a wide variety of use cases. For example, interactive flat panel devices (IFPDs) in universities and K12 schools are shared by multiple teachers, open pluggable specification (OPS) devices are shared by multiple employees in conference rooms, and public computer terminals are shared by multiple users. However, shared computing device users may not be able to store all of their private data in a physical storage of a shared computing device because of security and privacy considerations, and size limitations of the physical storage. In the cloud and edge era, where end users are immersed in seamless shared computing devices and remote services, the boundary between cloud, edge, and local devices is blurred, and more computing devices can easily access cloud resources including cloud storage.

Examples disclosed herein enable users to map their personal remote cloud storage to local storage of a shared computing device (e.g., the remote cloud storage appears as a personalized local storage), which may provide benefits such as native performance, low latency, and a similar user experience as local physical storage. Systems, methods, and apparatus disclosed herein provide a platform-level self-adaptive cloud storage cache partitioning approach for multiple users sharing a computing device. Examples disclosed herein enable platform-level technology bound to a basic input/output system (BIOS) to provide a virtual local storage (VLS) to an operating system (OS) and applications with near native input/output (IO) performance. Examples disclosed herein simulate a personalized VLS with a self-adaptive data block recycling strategy, configurable cache pre-fetching strategy, as well as a self-adaptive cache partitioning strategy for use among multiple users' VLSs within the same PCS.

Examples disclosed herein sync and manage storage with data blocks (e.g., not files) with a block IO read/write proxy at the platform level below the level of awareness of the OS. Each individual user's cloud storage is managed as a Cloud Private Storage (CPS) image file which has all data blocks of its respective user. Each user is allocated with a VLS which is a subset of the users CPS cached with the most frequently used data blocks. All OS level data access to native storage is redirected to the VLS by a platform level proxy, if not cached, the proxy fetches the data from the remote CPS and updates the local VLS. Therefore, the VLS/CPS image corresponding to a user can be identified as a “virtual hard disk” from the perspective of the OS.

In some examples, the shared computing device includes a suite of data structures (e.g., a user table, an index table, and a data block region) to support the PCS partitioning and VLS management. In some examples, each VLS is exposed to the OS and the applications for reading and writing with data blocks for a specific user. In some examples, each individual user's CPS is mapped to its VLS which other users cannot access.

In some examples, the shared computing device includes a Self-adaptive Cache Partitioning Engine (SCPE) (e.g., a partition manager) and Cache Control Strategy circuitry (CCS) to optimize the cache hit rate of VLSs in the PCS. In some cases, one or both of the SCPE and CCS are configurable with parameters which are stored in a policy database. An example SCPE provides a self-adaptive data block reassignment approach between multiple VLSs to optimize the overall cache hit rate. An example CCS controls how data blocks are prefetched from the CPS and recycled within the VLS to improve the cache hit rate of the VLS. The example policy database stores the configurable parameters set by administrators, such as a SCPE repartition period and a number of CCS pre-fetch blocks and recycle blocks.

In some examples, a Pre-boot Read-Write Proxy (PRWP) and a Run-time Read-Write Proxy (RRWP) are used to connect the VLS to the OS and the applications. Using the PRWP and the RRWP to connect an individual user's VLS and expose the VLS to a boot loader and the OS as a generic storage device enables the boot loader and the OS to run on the VLS as it would on a typical physical storage medium (e.g., a hard drive). Disclosed examples work for any type of OS because the PRWP and the RRWP are block based and not bound to any specific OS.

Disclosed examples enable multiple users to share a size-limited PCS which may be smaller than a total size of multiple CPSs. In some examples, the storage size between multiple users can be dynamically reallocated. Disclosed examples enable efficient software launch times and large file reading with low latency by an on-demand caching mechanism.

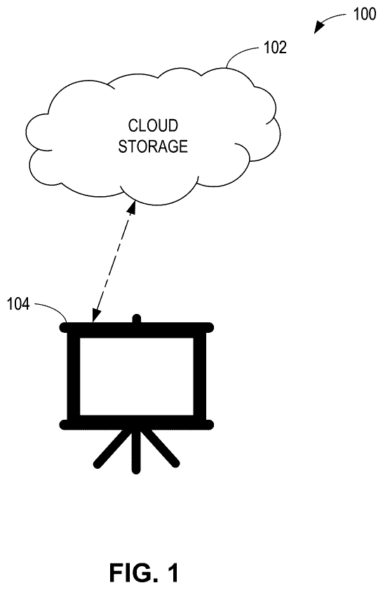

FIG. 1 is a block diagram of an example environment 100 including a cloud storage 102, and a shared computing device 104 connected to the cloud storage 102. For example, the shared computing device 104 can include a flat panel device (IFPD), open pluggable specification (OPS) devices, or public computer terminals. In other examples, the shared computing device 104 can include any computing device that is shared by multiple users. Further, in some examples, the shared computing device includes a network interface to provide access to a first cloud storage including first user data and second cloud storage including second user data.

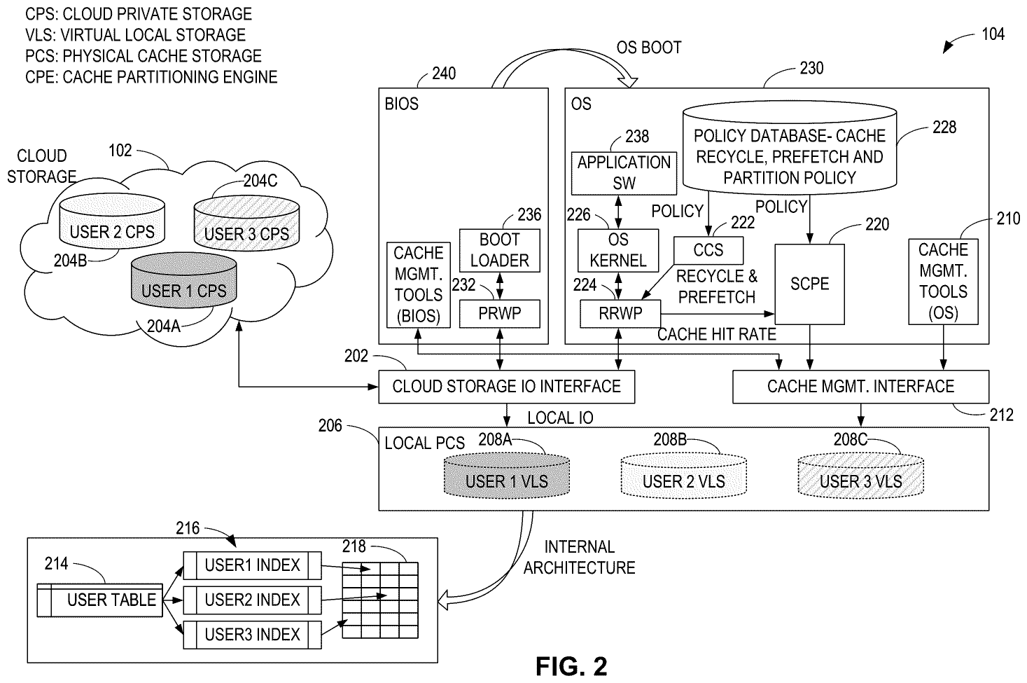

FIG. 2 is a block diagram illustrating the example shared computing device 104 of FIG. 1. The shared computing device 104 is connected to the cloud storage 102 through a cloud storage input/output (I/O) interface 202. In some examples, a first user, a second user, and a third user of the shared computing device 104 have a private CPS storage 204A-C in the cloud storage 102. The shared computing device 104 includes a local physical cache storage (PCS) 206 (e.g., a solid state drive (SSD), hard drive, etc.), where the users store data in a first, second, and third private virtual local storage (VLS) 208A-C in the PCS 206. The PCS 206 and the VLSs 208A-C are initialized and managed by cache management tools 210 through cache management interface 212. Each VLS 208A-C includes three internal data structures—a user table 214, an index table 216, and a data block region 218.

Both the local VLSs 208A-C and remote CPSs 204A-C are managed with raw data blocks, and do not depend on any specific file system. So, the approach works for any OS and file systems. The VLSs 208A-C can be a subset of the user's CPS 204A-C, and only the most required data blocks are cached in local VLSs 208A-C. The size of the VLSs 208A-C can be dynamically adjusted (e.g., repartitioned among multiple VLSs 208A-C within the same PCS 206), either manually through the cache management interface 212 by a system administrator or automatically by the self-adaptive cache partitioning engine (SCPE) 220. The SCPE 220 is used to repartition (e.g., change at least one partition size) the PCS 206 among the VLSs 208A-C to reduce the current VLS 208A-C cache miss rate. As to the intra-VLS control, the cache control strategy (CCS) 222 controls how data blocks are prefetched and recycled within the current VLS 208A-C to reduce the frequent caching from the cloud storage 102.

The RRWP 224 associated with the OS kernel 226 determines the current cache hit rate, which is used as an input for the SCPE 220. A policy database 228 stores pre-defined cache control policies from system administrators, such as number of recycle blocks and pre-fetch blocks parameter for the CCS 222 and the period of VLS repartitioning for the SCPE 220, further improving the recent cache hit rate and overall performance.

The OS 230 and upper-level application's block reading and writing to current VLS 208A-C are through the PRWP 232 and the RRWP 224. The PRWP 232 is a unified extensible firmware interface (UEFI) driver to transparently forward a boot loader's 236 reading/writing from storage to VLS 208A-C during a pre-boot period, enabling the boot loader 236 to run on top of the VLSs 208A-C. Similarly, the RRWP 224 is a OS 230 level driver. It also floats the OS 230 and entire software stack on top of VLSs 208A-C. Hence, no changes or customization to the native boot loader 236, the OS 230, or the applications 238 are required.

To support the CCS's 222 self-adaptive block recycling and prefetch mechanism within the current VLSs 208A-C and the SCPE's 220 PCS 206 re-partitioning among multiple VLSs 208A-C, three separated data structures are used to manage the individual user's VLSs 208A-C as described below.

User table 214 is used by current users to address data blocks in the VLSs 208A-C. The user table 214 stores meta information of each VLS 208A-C, including size of its CPS 204A-C, allocated block size at the local PCS 206 (e.g., total cached size, no more than the CPS 204A-C size), current allocated block size (e.g., current cached size), pointer to its index table 216, and the head of “next/prev” doubly linked list to track each data block.

Index table 216 is used by a specific user to store data block index and pointer to that block in data block region 218. The doubly linked list “next/prev” pointers are used to track and record the data blocks according to the access time—headed/tailed from “next/prev” defined in the user table 214 one by one. The usage of this pointer is explained further below.

Data block region 218 and bitmap is a storage region where all data blocks are stored. Each data block is pointed to by index table entries and physically stored in the local PCS 206. The bitmap is used with data block region to indicate which block is used in the data block region 218.

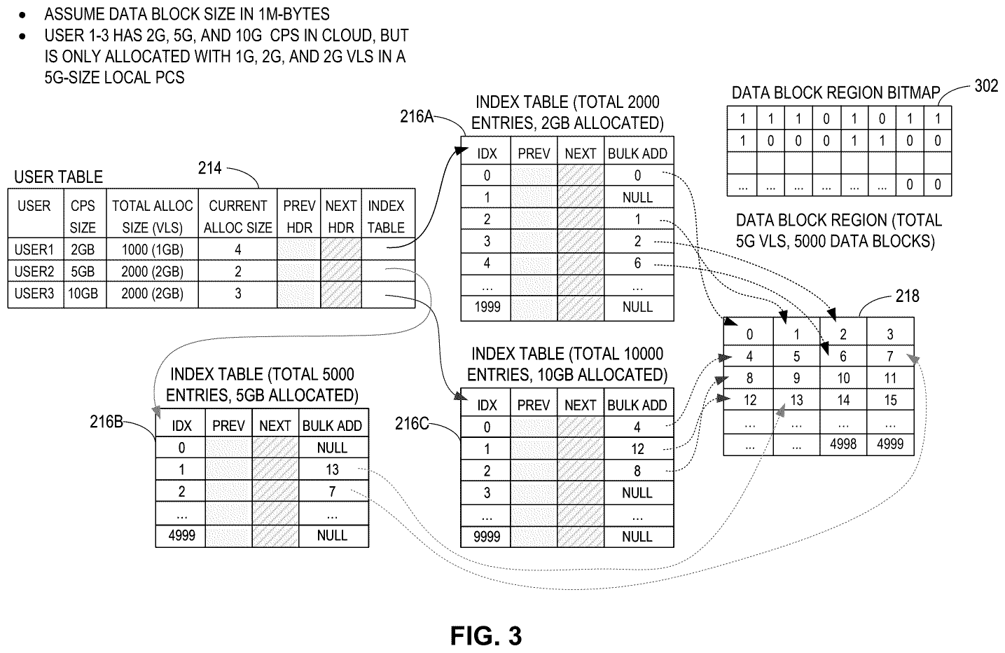

FIG. 3 is a block diagram illustrating an example local cache storage management in the example shared computing device 104. Three users—user 1, user 2 and user 3—have a 2 gigabyte (GB), a 5 GB and a 10 GB CPS 204A-C respectively, and a 1 GB, a 2 GB and a 2 GB VLS 208A-C space allocated in the local PCS 206. Assuming the block size is 1 megabyte (MB), these users have 2000, 5000 and 10000 entries in their individual index tables 216A-C.

There are 4 blocks allocated for user 1 which are tracked in the index table 216A. VLS block #0 is pointing to data block region 218 block #0 (data blocks). VLS block #2 is pointing to data block region 218 block #1, and VLS block #3 to #2, VLS block #4 to #6. VLS block #1 has no local copy, so it points to NULL pointer. The data blocks of user 2 and user 3 can be found similarly. The access of each user's VLS 208A-C can be found by accessing the user table 214, index tables 216A-C and corresponding data blocks in data block region 218 in turn. The corresponding bits in a data block region bitmap 302 is set with 1 if that block is used, otherwise is cleared with 0.

The current allocated size of the user table 214 is to record how many blocks have been allocated for this user. If all blocks have been allocated but this user still needs to read/write VLS 208A-C, some least-needed data blocks must be released for new blocks. To get better cache hit rate for the current user, other non-active user's VLS blocks could also be released and reassigned to current user, so both current user and donating non-active user's current allocated size should be updated. This is what “cache repartitioning” means.

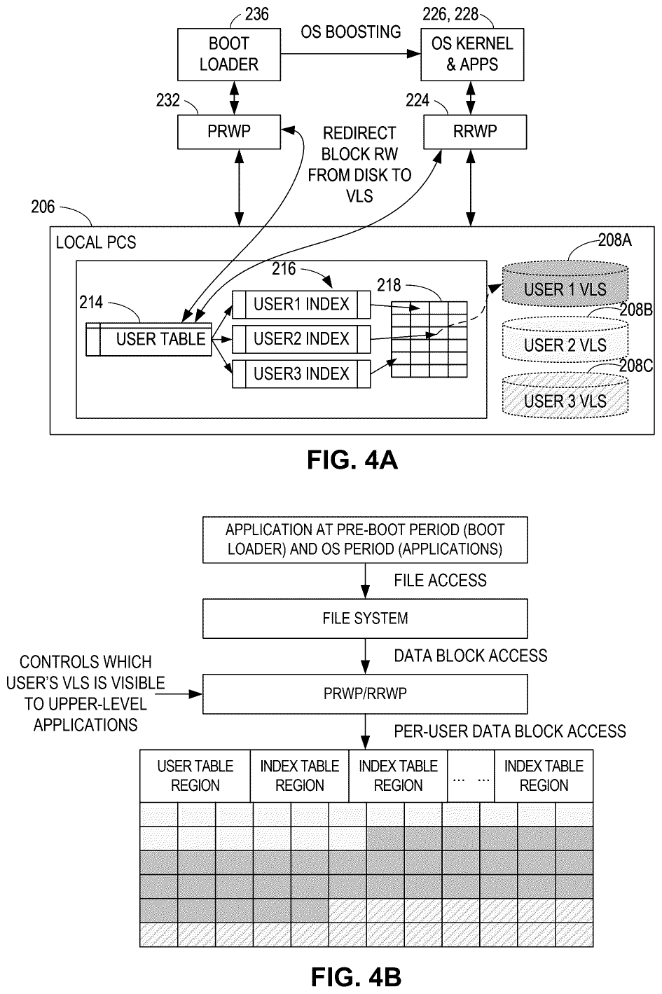

FIG. 4A is a diagram illustrating a physical view of the Pre-boot Read-Write Proxy (PRWP) 232 and the Run-time Read-Write Proxy (RRWP) 224 in the example shared computing device 104. FIG. 4B is a diagram illustrating a logical view of the PRWP 232 and the RRWP 224 in the example shared computing device 104. Regarding the OS 230, transparent means the boot loader 236, the OS 230, and the upper-level applications 238 should access VLSs 208A-C as if there was a real local storage below the platform. The PRWP 232 and the RRWP 224 are used to abstract the VLSs 208A-C and “cheat” the upper-level boot loader 236, the OS 230, and the applications 238 during either pre-boot period or run-time period.

The example PRWP 232 is a UEFI driver loaded within the platform BIOS 240 during pre-boot period. It intercepts block IO reading and writing since boot loader and redirect to correspondent data block reading/writing to VLSs 208A-C. So, from the boot loader 236 perspective, it continuously fetches data blocks from the virtualized “storage” which is the VLSs 208A-C indeed. Similarly, during the OS 230 run-time period, the RRWP 224 is an OS-level device driver which also intercepts the block reading and writing from upper-level applications 238 and OS kernel threads to the correspondent VLS data blocks, and “cheat” them as a real disk storage. The work is done at the BIOS 240 and the OS kernel 226 level, so it is transparent to the boot loader 236, the OS 230, and the upper-level applications 238.

The example PRWP 232 is a platform BIOS model that could be used to increase Intel Architecture (IA) stickiness. The pre-boot applications (boot loader or other UEFI applications) and the run-time OS applications 238 access files within file systems. Unlike the OS 230, the file system does not access data blocks from the PCS 206, disclosed examples access data blocks from the VLSs 208A-C through the PRWP 232 and the RRWP 224. Because there are multiple VLSs 208A-C beneath, system administrators can control which user's VLSs 208A-C would be exposed through the PRWP 232 and the RRWP 224. This naturally brings access control security features-only the virtualized VLS 208A-C is visible to the upper-level OS 230 and the applications 238, and they cannot see other user's VLS 208A-C and non-VLS content in the same PCS 206. This isolates each VLS 208A-C to each other and enables data privacy for each user.

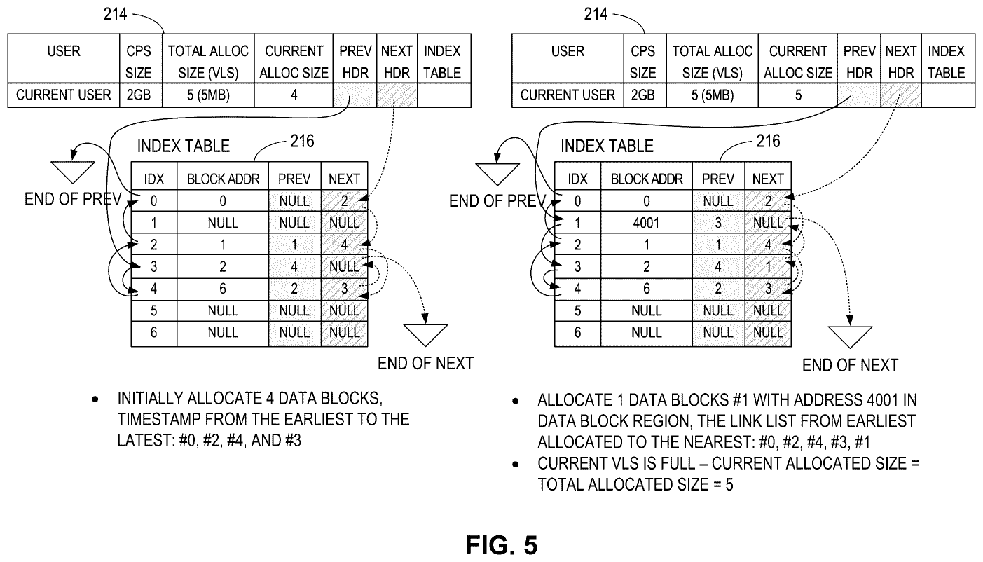

FIG. 5 is a block diagram illustrating an example of initialization and allocation of an example index table 216 in the example shared computing device 104. When a user is applying data blocks to read and write, the data blocks are allocated immediately if “current allocated size” is smaller than “total allocated size” in the user table 214, otherwise data blocks are recycled from the current user's VLS 208A-C. Initially, a user is allocated with block #0, #2, #4 and #3 in its VLS 208-C. All allocated data blocks are indexed and managed by a doubly linked list—“next & prev”—according to their importance (e.g., if the later access is assumed to be more important). The earlier the block is accessed (e.g., allocate/read/write), the closer this block is to the “next” and the farther to the “prev”. The total allocated size is 5, standing for 5 MB VLS size, while current allocated size is 4.

When some new blocks are required to add to the PCS 206, there are still available data blocks in local VLS 208A-C because “current allocated size” (4) is smaller than “total allocated size” (5), so a new data block (#1) is allocated immediately and appended to the doubly linked list. As can be seen, the next of #3 is changed to #1, and next of #1 is NULL indicating the end of “next” list. Accordingly, the previous node of #1 is #3. Also, “current allocated size” in the user table 214 was updated to 5 accordingly.

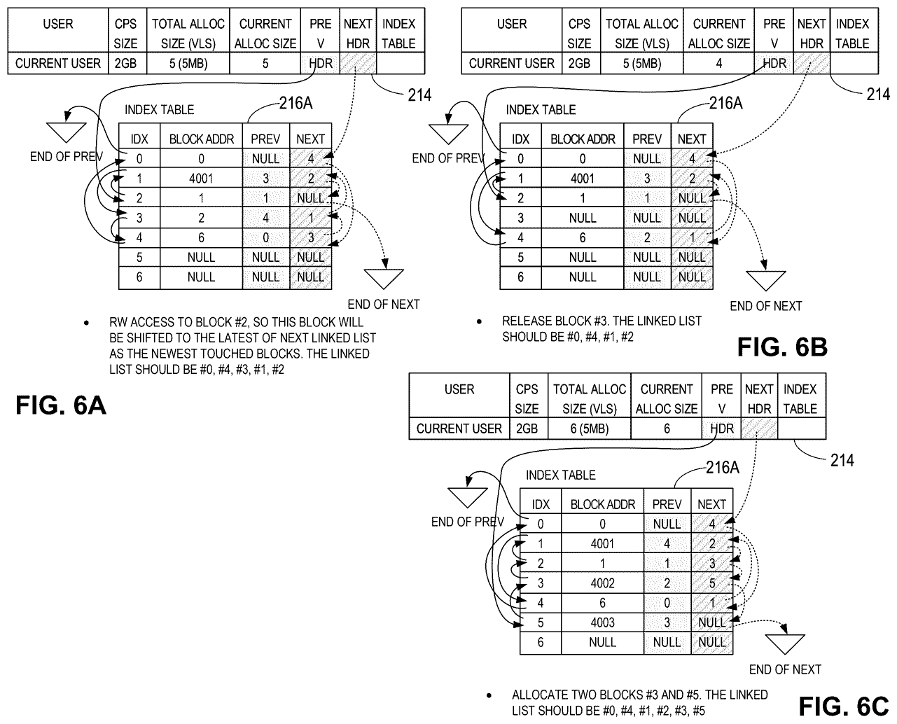

FIGS. 6A-6C are block diagrams illustrating an example of access, release, and expansion of the VLS 208A in the example shared computing device 104. If some already-cached blocks in the VLS 208A are being written/updated while the system is running (e.g., change some bytes in this data block), as illustrated in FIG. 6A. Block #2 is accessed (e.g., touched) recently, becoming the newest block at this stage. This block is moved to the last of “next” (earliest of “prev”) doubly linked list. The current previous and next node of block #2 should be updated accordingly.

FIG. 6B depicts how to release an old block #3, as an example that some least-used data blocks need to be released and reassigned to newer data blocks. Also, the current allocated size field in the user table 214 should be decreased accordingly.

When the VLS 208A is full, but data blocks still need to be allocated, the VLS 208A is expanded. FIG. 6C illustrates this. Besides the updating of new entries in the index table 216A, the “total allocated size” and “current allocated size” in the user table 214 should be updated as well.

The allocation, updating and release of data blocks within the VLS 208A are regarded as primitives of the VLS 208A manipulation. In some examples, the VLS size among multiple users needs to be adjusted. For example, a new user—for instance, user 4—is joining the shared computing device but the PCS 206 space is full, so users 1-3 must allocate 500 MB VLS space for user 4. With the primitives above, the oldest blocks of each user are released back to the PCS 206 through the “next” list, a new entry in user table and a new index table for user 4 are created. When user 4 is mounted to this device, its data blocks are gradually provisioned from the cloud storage system 102, mapped to an index table, and cached to a VLS.

The PCS 206 repartition can be done in either the BIOS 240 stage during pre-boot period, or the SCPE 220 during run-time period which is explained in the next section.

The SCPE 220 is used to automatically repartition the PCS 206 and manage multiple VLSs 208A-C when adding a new VLS to the PCS 206 during pre-boot time or optimizing PCS layout to get higher cache hit rate for the current VLS 208A-C during OS run-time. The more space the VLSs 208A-C have, the higher the cache hit rates are in general. However, the total blocks of all VLSs 208A-C are more than that of the PCS 206. So, an automatic block allocation strategy for multiple VLSs 208A-C within the PCS 206 is utilized.

The SCPE 220 operates based on the assumption that the data access style of each VLS 208A-C is similar—it's not likely the access to one VLS 208A-C is focused on a small region, while another VLS 208A-C is accessed sparsely. This makes the VLS 208A-C hit rate similar among multiple users. This is mostly true because the usage of shared device 104 for each user would be quite similar. Further, the SCPE 220 operates based on the assumption that the more blocks a VLS 208A-C has, the higher cache hit rate it has and the recent VLS 208A-C should have a higher priority to allocate blocks than older VLS 208A-C, so if recent VLS 208A-C needs more data blocks, its needs are fulfilled by recycling from older VLSs 208A-C.

The below parameters are used for the SCPE 220 configuration and stored in the policy database 228. Minimal acceptable cache rate is the lowest cache rate that is acceptable. It's used when adding a new VLS 208. If the existing average cache rate is lower than this value, the current PCS 206 is very congested and old VLS(s) 208A-C should be released, cannot further shrink current VLS's 208A-C cache rate. Negligible cache rate is defined as during the optimization of PCS repartitioning, if the gap of cache rate of two VLSs 208A-C is smaller than this value, the difference is negligible. This is to handle float to integer conversion problem of the algorithm. Optimization period is defined as the period (e.g., number of seconds) of regular optimization to all VLSs 208A-C within the PCS 206. Once every period, the VLS size of the PCS 206 is optimized according to the algorithm below. Satisfied cache hit rate is defined as the cache hit rate which is acceptable by system administrators. For example, 80%. This value is used by the optimization phase to determine whether further optimization is required.

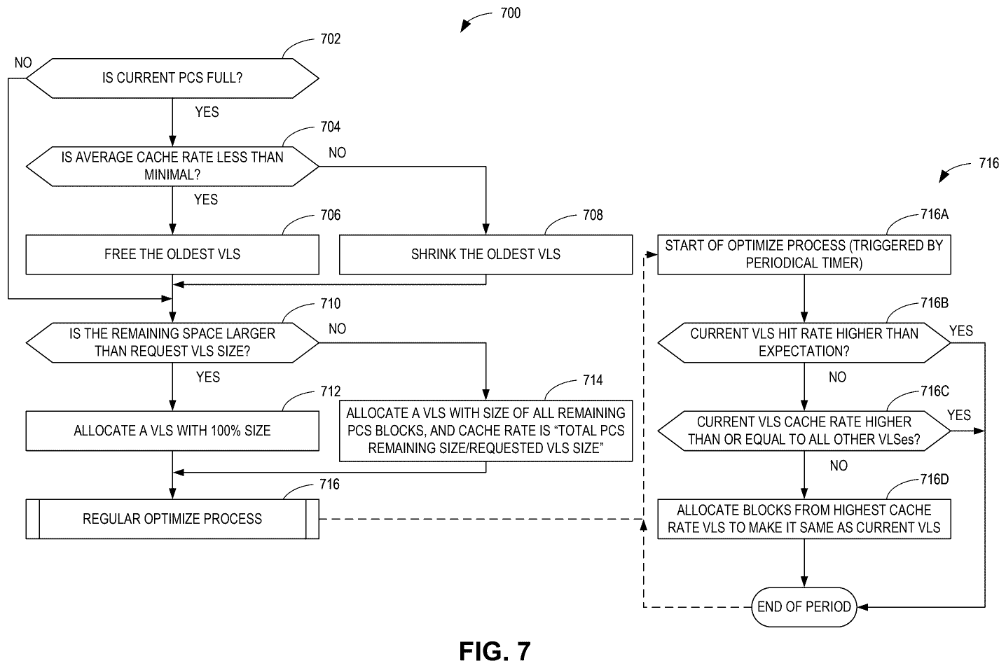

FIG. 7 is a flowchart illustrating an example process 700 for allocation of a new VLS 208 to the PCS 206 and physical cache storage optimization in the example shared computing device 104.

In some examples, the SCPE 220 receives a request to add a new VLS 208 to the PCS 206 of the shared device 104. Beginning at block 702, the SCPE 220 determines if the PCS 206 is full and no free space is available. If the PCS 206 is full control transitions to block 704. Alternatively, if the PCS 206 is not full control proceeds to block 710.

At block 704 the SCPE 220 determines whether the average cache rate is less than the minimal acceptable cache rate (e.g., the PCS 206 is congested with existing VLSs 208A-C). If the average cache rate is less than the minimal acceptable cache rate control proceeds to block 706. Alternatively, if the cache rate is not less than the minimal acceptable cache rate control proceeds to block 708.

At block 706 the SCPE releases (e.g., deletes) the oldest VLS and control proceeds to block 710.

At block 708 the SCPE 220 shrinks the oldest VLS to free up space in the PCS 206 and control proceeds to block 710.

At block 710 the SCPE 220 determines if the remaining space in the PCS 206 is larger than the new VLS 208. If the remaining space in the PCS 206 is larger than the new VLS 208 control proceeds to block 712. Alternatively, if the remaining space in the PCS 206 is not larger than the new VLS 208 control proceeds to block 714.

At block 712 the SCPE 220 allocates the new VLS 208 with a 100% cache size and control proceeds to block 716.

At block 714 the SCPE 220 allocates the new VLS 208 with all remaining blocks in the PCS 206, so the cache rate corresponds to the total space remaining in the PCS 206. Control then proceeds to block 716.

At block 716 the SCPE 220 initialize a periodic timer to continuously repartition (e.g., optimize) PCS layout according to the recent cache hit rate from the RRWP 224. In some examples, the period of optimization is configured by system administrator and stored in the policy database 228 (e.g., 5 seconds).

At block 716A the optimization process 716 is triggered when the periodic timer resets and control proceeds to block 716B.

At block 716B the SCPE 220 determines if the cache hit rate is lower than a desired cache hit rate (e.g., also a pre-configured parameter stored in the policy database 228). If the current VLS cache hit rate is higher than the desired cache hit rate, the SCPE 220 returns immediately because the current PCS layout is satisfactory. Alternatively, control proceeds to block 716C.

At block 716C the SCPE 220 determines if the cache rate is higher than all other VLSs 208A-C (e.g., already highest, do not need to repartition again). If the cache rate is higher than all other VLSs 208A-C, it returns immediately. Alternatively, control proceeds to block 716D.

At block 716D the SCPE 220 releases some space of the VLS 208A-C with highest cache rate so the final cache rate (r) of the VLS 208A-C with highest cache rate and the new VLS 208 have the same cache rate. The highest cache rate VLS's 208A-C CPS size is s1 and cache rate is r1, current VLS's CPS size is s2 and cache rate is r2, so the final average cache rate is r=(r1*s1+r2*s2)/(s1+s2). Hence the final cached size of highest cache rate VLS is r*s1 and the final cached size of current VLS is equal to r*s2)

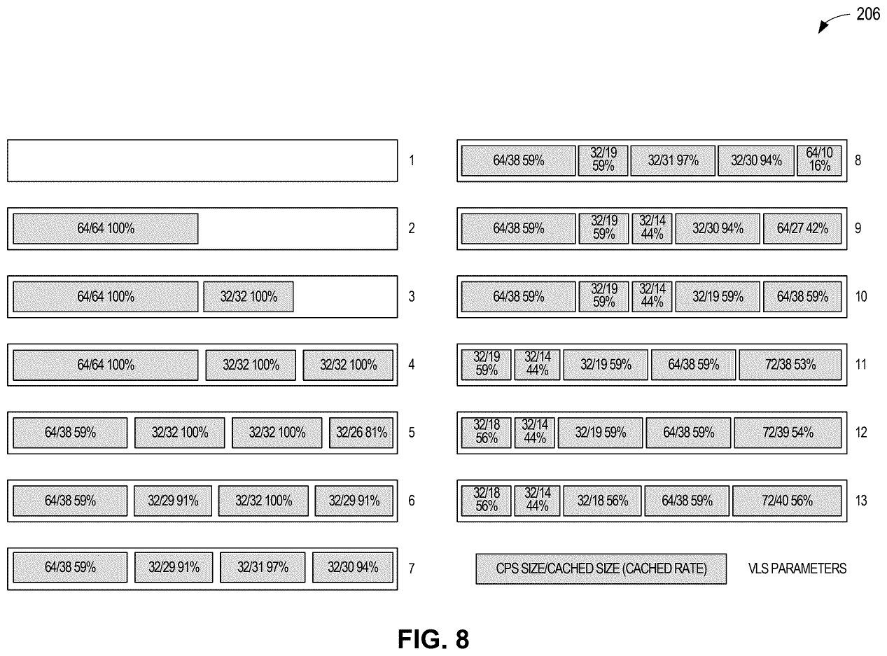

FIG. 8 is a diagram illustrating the example PCS 206 of FIG. 2 in different stages of the example process of FIG. 7. Assume the PCS 206 has size 128, and VLSs 208 with sizes 64, 32, 32, 32, 64, 72 are added to the PCS 206 one by one. After each VLS 208 is added, a couple of optimizations are applied to the current PCS 206 until optimal. For example, the minimal acceptable cache rate is 60% and negligible cache rate is 5%. In such example, at stage 1 the PCS 206 is initialized with size 128. Next, at stage 2 the first VLS 208 is added with size 64. Because the PCS 206 has enough space to accommodate the first VLS 208, the first VLS 208 is added with 100% cache rate. Then, during stages 3 and 4, second and third VLSs 208 with size 32 and 32 are added, both with 100% cache rate.

Up until now, all VLSs 208 have had a 100% cache rate, so no optimization is needed. Now, at stage 5 a fourth VLS with size 32 is added. Because the average cache rate is 100%, which is higher than the minimal acceptable cache rate (60%), the oldest VLS (e.g., the first VLS) is repartitioned to the minimal acceptable cache rate and the released data blocks are reassigned to the fourth VLS. At stage 6, when the period timer resets, the SCPE 220 optimizes the PCS layout. Because the fourth VLS cache rate (81%) is less than the cache rate of the second and third VLSs 208, the SCPE 220 adjusts the cache rate of the fourth VLS and the second VLS to the same cache rate (both with 91%). At stage 7, because the fourth VLS cache rate (91%) is less than the cache rate of the third VLS (100%), it repartitions both the third and fourth VLSs to a same value (e.g., 97% and 94% because the gap is less than negligible cache rate 5%). At stage 8, a fifth VLS 208 with size 64 is added. Because all VLSs cache rate is higher than the minimal acceptable cache rate, it shrinks the VLS with the biggest cache rate to the minimal acceptable cache rate and repartitions the space to the fifth VLS (16%). At stage 9, the new layout is optimized by taking the average of the VLS 208 with the highest cache rate (e.g., the third VLS) and the fifth VLS. At stage 10 optimization continues and the average of the VLS with the highest cache rate and the fifth VLS is repartitioned to 59%. At stage 11 a new VLS with size 72 is added, and because average cache rate (57%) is less than minimal acceptable cache rate, it releases the oldest VLS and allocates space for new VLS (cache rate 53%). At stage 12 the PCS layout is optimized by taking the average of maximal VLS (59%->56%) and current VLS (53%->54%). At stage 13 the PCS layout is further optimized by taking the average of maximal VLS (59%->56%) and current VLS (54%->56%).

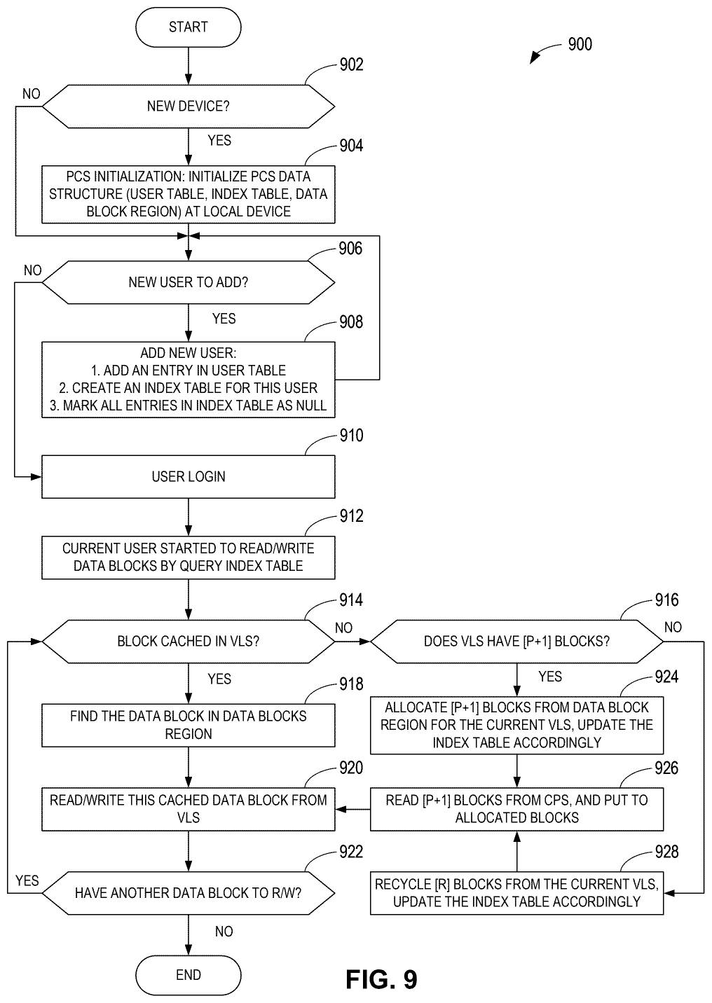

FIG. 9 is a flowchart illustrating an example process 900 which can be implemented by the SCPE 220 to perform initialization of the PCS 206 and to perform read/write operations in the example shared computing device 104. At block 902 the SCPE determines if the shared computing device 104 has been previously initialized. If the shared computing device 104 has been previously initialized control proceeds to block 906. Alternatively, if the shared computing device 104 has not been previously initialized control proceeds to block 904.

At block 904 the SCPE 220 initializes a local user table, a data block region as the repository to store all users' data blocks, and allocates the user index table for storing user meta data. Control then proceeds to block 906.

At block 906 the SCPE 220 determines whether a new user is to be added to the shared computing device 104. If a user is to be added to the shared computing device 104 control proceeds to block 908. Alternatively, if a user is not to be added to the shared computing device 104 control proceeds to block 910.

At block 908 a new entry is created in the user table and an independent index table is created for the new user. All entries in the index table should be marked NULL initially to indicate no data blocks are cached in its VLS, so all data blocks are in remote cloud. Control then proceeds back to block 906.

At block 910 the SCPE 220 waits for a user to log into the shared computing device 104. Control then proceeds to block 912.

At block 912 the SCPE 220 waits for a user to start a read/write process. When boot loader, OS and upper-level application software start to read/write a data block, PRWP or RRWP captures the read/write request control proceeds to block 714.

At block 914 the SCPE 220 determines whether the block is cached in the current VLS. If the block is cached in the current VLS control proceeds to block 918. Alternatively, if the block is not cached in the current VLS control proceeds to block 916.

At block 918, the SCPE 220 addresses and reads or writes the data block in the data block region. Control then proceeds to block 920.

At block 916 the SCPE 220 prepares data block space through the CCS by determining if the current VLS has P+1 blocks where P is the size of the data block. If the current VLS has P+1 blocks control proceeds to block 924. Alternatively, if the current VLS does not have P+1 blocks control proceeds to block 928.

At block 924 the SCPE 220 allocates data blocks from the current VLS. Control then proceeds to block 926.

At block 928 the SCPE 220 recycles data blocks from the current VLS to make room for the data block. Control then proceeds to block 926.

At block 926 the SCPE 220 performs the read or write operation of the data block from the CPS. Control then proceeds to block 920.

At block 920 the SCPE 220 performs the read or write operation from the current VLS. Control then proceeds to block 922 where the SCPE 220 determines whether there is another data block to perform a read or write operation on. If there is another data block control proceeds to block 914. Alternatively, the process 900 ends.

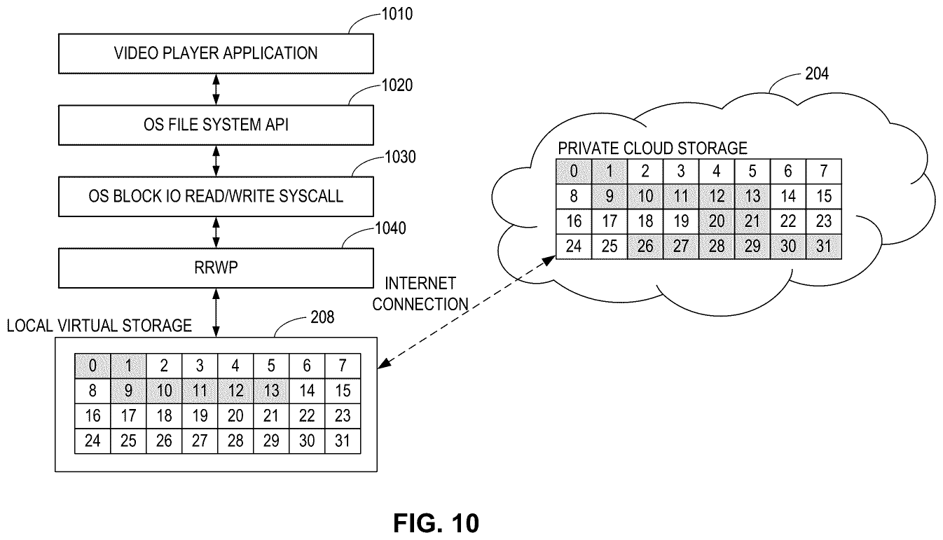

FIG. 10 is a block diagram illustrating a on-the-fly reading/writing process from the VLS 208 in the example shared computing device 104. One advantages of the disclosed approach is, even when data blocks of large file or software is not totally cached at the VLS 208, the user does not need to wait for all data to be downloaded and cached, such as a large software like 3D animation software or a game with large data file. The following is an example of how this happens.

For example, the video player application 1010 plays a large video file from the VLS 208. The video player application 1010 invokes an OS file system API 1020. The OS file system API 1020 commands an OS-level block IO read/write system 1030. Then the block IO reading/writing is captured by a RRWP 1040 (run-time read/write proxy). Assume the video file has block #0-1, 9-13, 20-21, 26-30, total 14 blocks. However, only 0-1 and 9-13 are cached at the VLS 208. So, when the video player application 1010 needs to read/write the cached data blocks, the RRWP 1040 returns immediately. Otherwise, it picks up the missing data blocks from the remote CPS 204. This avoids waiting for downloading of large data files from the CPS 204. Regarding the block IO read/write that are intercepted below the OS block IO read/write system call, this does not impact the applications above that system call, like the video player application 1010, which runs as if the native storage (e.g., hard disk) is there. Further, the storage access is block by block, so it does not need to wait for long time to download the entire file.

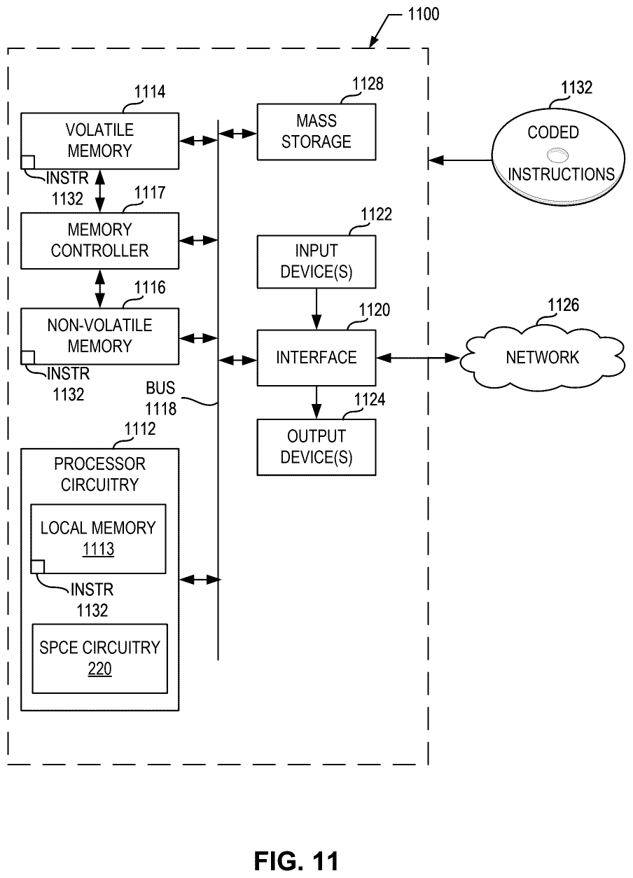

FIG. 11 is a block diagram of an example programmable circuitry platform 1100 structured to execute and/or instantiate the example machine-readable instructions and/or the example operations of FIGS. 7 and 9 to implement the shared computing device 104 of FIG. 2. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, VPUs, DSPs, and/or microcontrollers from any desired family or manufacturer. The programmable circuitry 1112 may be implemented by one or more semiconductor based (e.g., silicon based) devices.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 7 and 9, may be stored in the mass storage device 1128, in the volatile memory 1114, in the non-volatile memory 1116, and/or on at least one non-transitory computer readable storage medium such as a CD or DVD which may be removable.

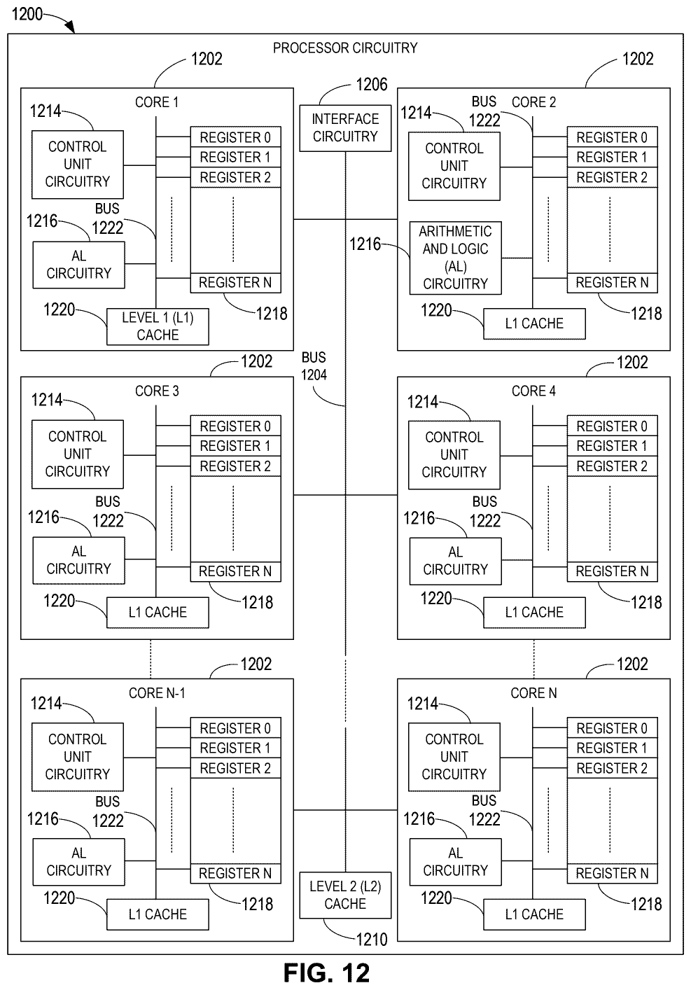

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 7 and 9 to effectively instantiate the circuitry of FIG. 2 as logic circuits to perform operations corresponding to those machine readable instructions. In some such examples, the circuitry of FIG. 2 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 7 and 9.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

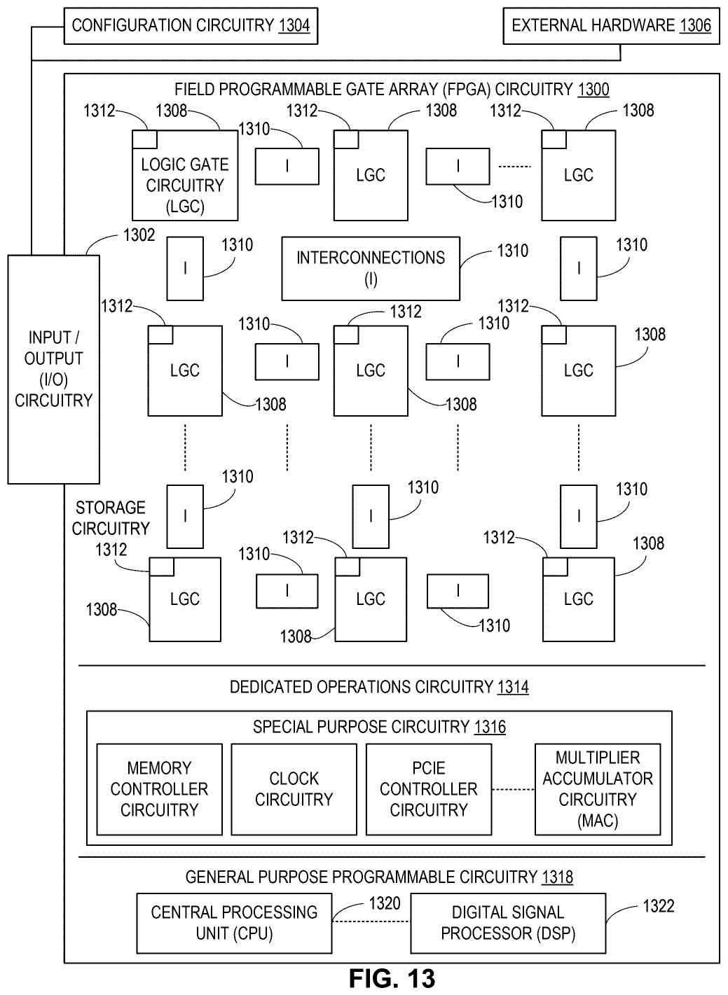

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 7 and 9 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7 and 9. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7 and 9. As such, the FPGA circuitry 1300 may be configured and/or structured to effectively instantiate some or all of the operations/functions corresponding to the machine readable instructions of the flowchart(s) of FIGS. 7 and 9 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 7 and 9 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 7 and 9 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 7 and 9 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 7 and 9, and/or an ASIC may be configured and/or structured to perform third operation(s)/function(s) corresponding to a third portion of the machine readable instructions represented by the flowcharts of FIGS. 7 and 9.

It should be understood that some or all of the circuitry of FIG. 2 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

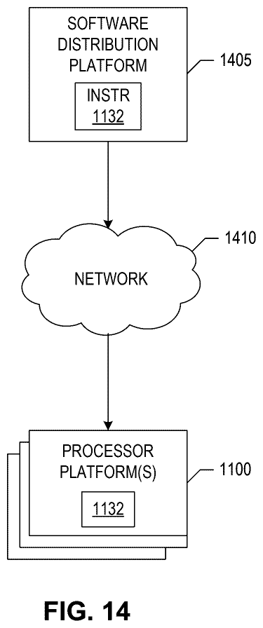

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 7 and 9, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIGS. 7 and 9, may be downloaded to the example programmable circuitry platform 1100, which is to execute the machine readable instructions 1132 to implement the shared computing device 104. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

It is noted that this patent claims priority from International Patent Application Number PCT/CN2024/140878, which was filed on Dec. 20, 2024, and is hereby incorporated by reference in its entirety.

Example systems, methods, and apparatus for partitioning for multi-user shared computing devices are disclosed herein. Further examples and combinations thereof include the following:
Example 1 includes a shared computing device comprising a network interface to provide access to a first cloud storage including first user data associated with a first user and a second cloud storage including second user data associated with a second user, a local storage including a first partition with a first partition size, where the first partition stores a subset of the first cloud storage, and a second partition with a second partition size, where the second partition stores a subset of the second cloud storage, and a partition manager to cause a change to the first partition size based on a first cache rate of the first partition and a second cache rate of the second partition, where the cache rates are a percentage of the first cloud storage and the second cloud storage stored in the respective partition.
Example 2 includes the shared computing device of example 1, wherein the first cloud storage includes an operating system (OS) associated with the first user and the second cloud storage includes an OS associated with the second user.
Example 3 includes the shared computing device of any one or more of examples 1-2, wherein the network interface is to provide access to a third cloud storage and the partition manager is to create a third partition within the local storage.
Example 4 includes the shared computing device of example 3, wherein the partition manager is to determine if a cache rate associated with the third partition is below a minimal acceptable cache rate, and if the cache rate is below the minimal acceptable cache rate, cause a change to the first partition.
Example 5 includes the shared computing device of example 4, wherein the partition manager reduces the first partition size of the first partition.
Example 6 includes the shared computing device of any one or more of examples 4-5, wherein the partition manager deletes the first partition.
Example 7 includes the shared computing device of any one or more of examples 1-6, wherein a first usage of the first partition is less than a second usage of the second partition.
Example 8 includes the shared computing device of example 7, wherein the first partition size is reduced to a minimal acceptable cache rate.
Example 9 includes a non-transitory machine readable storage medium comprising instructions to cause programmable circuitry including a memory to at least provide access to a first cloud storage including first user data associated with a first user and a second cloud storage including second user data associated with a second user, store a subset of the first cloud storage in a first partition of the memory and store a subset of the second cloud storage in a second partition of the memory, and cause a change to a first partition size associated with the first partition based on a first cache rate of the first partition and a second cache rate of the second partition, where the cache rates are a percentage of the first cloud storage and the second cloud storage stored in the respective partition.
Example 10 includes the non-transitory machine readable storage medium of example 9, wherein the first cloud storage includes an operating system (OS) associated with the first user and the second cloud storage includes an OS associated with the second user.
Example 11 includes the non-transitory machine readable storage medium of any one or more of examples 9-10, wherein the instructions cause the programmable circuitry to provide access to a third cloud storage and store a subset of the third cloud storage in a third partition of the memory.
Example 12 includes the non-transitory machine readable storage medium of example 11, wherein the instructions cause the programmable circuitry to determine if a cache rate associated with the third partition is below a minimal acceptable cache rate, and if the cache rate is below the minimal acceptable cache rate, cause a change to the first partition.
Example 13 includes the non-transitory machine readable storage medium of example 12, wherein the instructions cause the programmable circuitry to reduce the first partition size of the first partition.
Example 14 includes the non-transitory machine readable storage medium of any one or more of examples 12-13, wherein the instructions cause the programmable circuitry to delete the first partition.
Example 15 includes the non-transitory machine readable storage medium of any one or more of examples 9-14, wherein a first usage of the first partition is less than a second usage of the second partition.
Example 16 includes the non-transitory machine readable storage medium of example 15, wherein the first partition size is reduced to a minimal acceptable cache rate.
Example 17 includes a method comprising providing access to a first cloud storage including first user data associated with a first user and a second cloud storage including second user data associated with a second user, storing a subset of the first cloud storage in a first partition of a memory and storing a subset of the second cloud storage in a second partition of the memory, and causing a change to a first partition size associated with the first partition based on a first cache rate of the first partition and a second cache rate of the second partition, where the cache rates are a percentage of the first cloud storage and the second cloud storage stored in the respective partition.
Example 18 includes the method of example 17, wherein the first cloud storage includes an operating system (OS) associated with the first user and the second cloud storage includes an OS associated with the second user.
Example 19 includes the method of any one or more of examples 17-18, wherein a first usage of the first partition is less than a second usage of the second partition.
Example 20 includes the method of example 19, wherein causing the change to the first partition size includes reducing the first partition size to a minimal acceptable cache rate.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A shared computing device comprising:
a network interface to provide access to a first cloud storage including first user data associated with a first user and a second cloud storage including second user data associated with a second user;
a local storage including a first partition with a first partition size, where the first partition stores a subset of the first cloud storage, and a second partition with a second partition size, where the second partition stores a subset of the second cloud storage; and
a partition manager to cause a change to the first partition size based on a first cache rate of the first partition and a second cache rate of the second partition, where the cache rates are a percentage of the first cloud storage and the second cloud storage stored in the respective partition.

2. The shared computing device of claim 1, wherein the first cloud storage includes an operating system (OS) associated with the first user and the second cloud storage includes an OS associated with the second user.

3. The shared computing device of claim 1, wherein the network interface is to provide access to a third cloud storage and the partition manager is to create a third partition within the local storage.

4. The shared computing device of claim 3, wherein the partition manager is to determine if a cache rate associated with the third partition is below a minimal acceptable cache rate, and if the cache rate is below the minimal acceptable cache rate, cause a change to the first partition.

5. The shared computing device of claim 4, wherein the partition manager reduces the first partition size of the first partition.

6. The shared computing device of claim 4, wherein the partition manager deletes the first partition.

7. The shared computing device of claim 1, wherein a first usage of the first partition is less than a second usage of the second partition.

8. The shared computing device of claim 7, wherein the first partition size is reduced to a minimal acceptable cache rate.

9. A non-transitory machine readable storage medium comprising instructions to cause programmable circuitry including a memory to at least:
provide access to a first cloud storage including first user data associated with a first user and a second cloud storage including second user data associated with a second user;
store a subset of the first cloud storage in a first partition of the memory and store a subset of the second cloud storage in a second partition of the memory; and
cause a change to a first partition size associated with the first partition based on a first cache rate of the first partition and a second cache rate of the second partition, where the cache rates are a percentage of the first cloud storage and the second cloud storage stored in the respective partition.

10. The non-transitory machine readable storage medium of claim 9, wherein the first cloud storage includes an operating system (OS) associated with the first user and the second cloud storage includes an OS associated with the second user.

11. The non-transitory machine readable storage medium of claim 9, wherein the instructions cause the programmable circuitry to provide access to a third cloud storage and store a subset of the third cloud storage in a third partition of the memory.

12. The non-transitory machine readable storage medium of claim 11, wherein the instructions cause the programmable circuitry to determine if a cache rate associated with the third partition is below a minimal acceptable cache rate, and if the cache rate is below the minimal acceptable cache rate, cause a change to the first partition.

13. The non-transitory machine readable storage medium of claim 12, wherein the instructions cause the programmable circuitry to reduce the first partition size of the first partition.

14. The non-transitory machine readable storage medium of claim 12, wherein the instructions cause the programmable circuitry to delete the first partition.

15. The non-transitory machine readable storage medium of claim 9, wherein a first usage of the first partition is less than a second usage of the second partition.

16. The non-transitory machine readable storage medium of claim 15, wherein the first partition size is reduced to a minimal acceptable cache rate.

17. A method comprising:
providing access to a first cloud storage including first user data associated with a first user and a second cloud storage including second user data associated with a second user;
storing a subset of the first cloud storage in a first partition of a memory and storing a subset of the second cloud storage in a second partition of the memory; and
causing a change to a first partition size associated with the first partition based on a first cache rate of the first partition and a second cache rate of the second partition, where the cache rates are a percentage of the first cloud storage and the second cloud storage stored in the respective partition.

18. The method of claim 17, wherein the first cloud storage includes an operating system (OS) associated with the first user and the second cloud storage includes an OS associated with the second user.

19. The method of claim 17, wherein a first usage of the first partition is less than a second usage of the second partition.

20. The method of claim 19, wherein causing the change to the first partition size includes reducing the first partition size to a minimal acceptable cache rate.
